(19) United States
(12) Patent Application Publication
(10) Pub. No.: US 2003/0119374 A1
(43) Pub. Date: Jun. 26, 2003

(54) Short proof plug for ornamental light

(76) Inventor: Jessica Wang, Taipei (TW)

Correspondence Address: OSTROLENK FABER GERB & SOFFEN, 1180 AVENUE OF THE AMERICAS, NEW YORK, NY, 100368403

(21) Appl. No.: 10/033,972

(22) Filed: Dec. 26, 2001

(51) Int. Cl. H01R 24/00

(52) U.S. Cl. 439/699.1

(57) ABSTRACT

A short proof plug for an ornamental light has a cylindrical tube adapted to receive therein a part of the light bulb, an extension integrally formed on a bottom of the cylindrical tube; and two auxiliary arms formed on opposite sides of the extension and each auxiliary arm having a slit defined through the auxiliary arms to communicate with an inside of the cylindrical tube so that an isolation wall is formed between the two auxiliary arms.

### FIELD OF THE INVENTION

The present invention relates to a plug for an ornamental light, and more particularly to a short proof plug for an ornamental light. The plug has an isolation wall extending down from the plug so that when a light bulb is inserted into the plug, the wires extending from the bottom of the light bulb is completely separated from each other so as to accomplish the purpose of preventing a short to the light.

### BACKGROUND OF THE INVENTION

Ornamental light string is popular in seasonal festival, especially in Christmas Day. People use ornamental light string to decorate the Christmas tree, the roof and windows to share the seasonal joy with others. The conventional ornamental light string has a plug intended to be electrically connected with a power source, such as an outlet, multiple light bulbs securely and electrically connected with one another by wires. Each of the light bulbs has wires extending out from the bottom of the light bulb so as to connect to a power line to light the light bulb. A conventional ornamental light is shown in FIG. 1, wherein the light has a light bulb 50, a socket 60 and a socket receiving tube 70.

The light bulb 50 has wires 51 extending out from a bottom of the light bulb 50. The socket 60 has a through hole 61 defined through the socket 60 to receive a part of the light bulb 50 and a wall 62 formed on an inner face of the socket 60 to divide the bottom opening (not numbered) of the through hole 61 into two exits 621. The socket receiving tube 70 has two power lines 71 extending into the socket receiving tube 70 to respectively connect to one of the wires 51 of the light bulb 50 after the light bulb 50 is inserted into the socket 60 and the socket 60 is received in the socket receiving tube 70.

With reference to FIG. 2, after the light bulb 50 is assembled in the socket 60, it is noted that the wires 51 are separated by the wall 62 and thus extend out of the socket 60 from two different directions. However, even though the two wires 51 are separated by the wall 62, because the height of the wall 62 is not enough to completely isolate the two wires 51, the two wires 51 are still easy to have a short. It is known that the ornamental light is normally hung on the trees, on the roofs or any other outdoor objects that are able to enhance the festival atmosphere so that the ornamental light is very easy to be wet in rainy days. Therefore, on rainy days, a drop of water 80 may easily penetrate through the little space between the inner face of the socket 60 and the light bulb 50 and be caught between the two wires 51, which causes a short to the ornamental light.

To overcome the shortcomings, the present invention intends to provide an improved short proof socket for the ornamental light to mitigate or obviate the aforementioned problems.

### SUMMARY OF THE INVENTION

The primary objective of the invention is to provide a short proof socket for the ornamental light by providing an isolating wall extending inside the socket and engages with the bottom of the light bulb so that even there is water penetrating into the little space between the light bulb and the inner face of the socket, the isolating wall is still able to isolate the wires of the light bulb from each other so as to avoid the possibility of having a short.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing a conventional ornamental light;

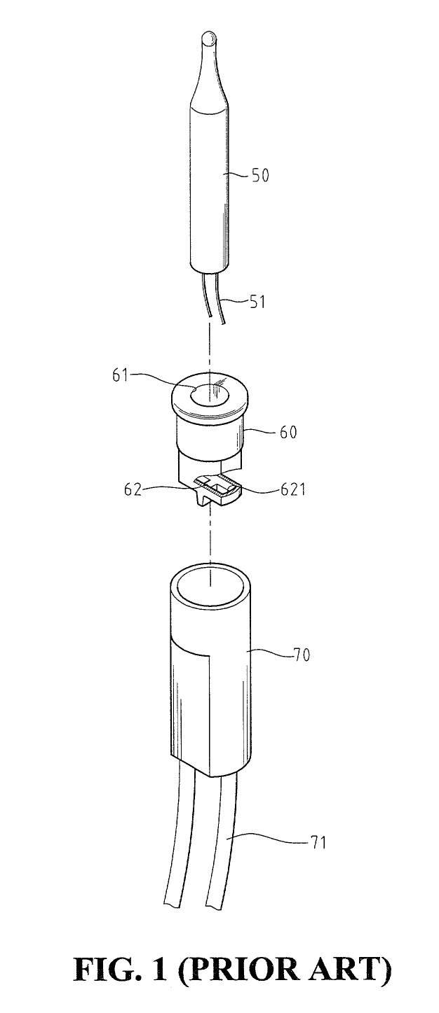

FIG. 2 is a plan view showing the light bulb is inserted into the conventional socket, wherein the socket is section for clarity;

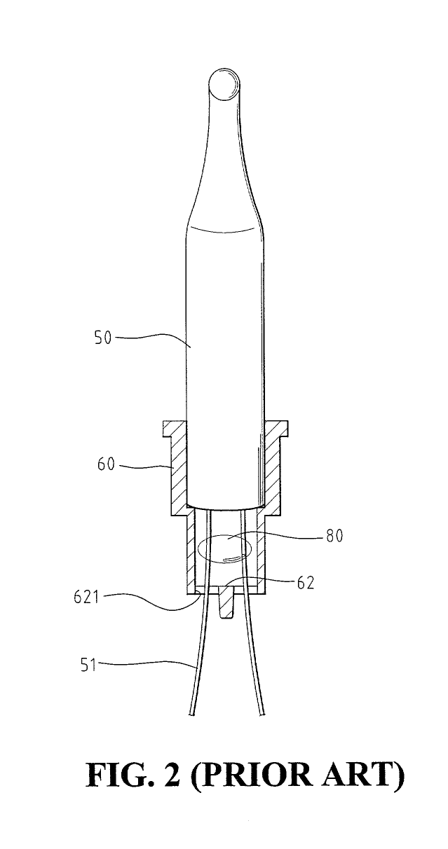

FIG. 3 is an exploded perspective view of the ornamental light of the present invention; and

FIG. 4 is a partial section view showing the inner structure of the ornamental light.

### DETAILED DESCRIPTION OF THE INVENTION

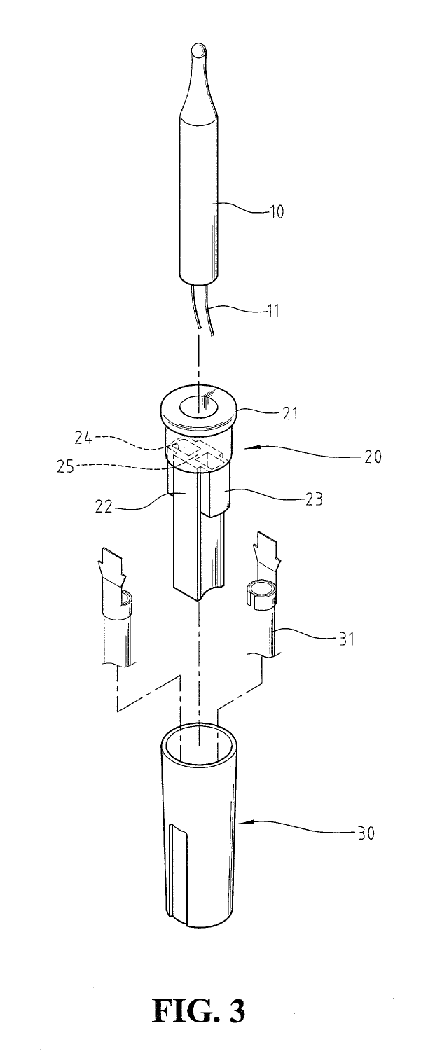

With reference to FIG. 3, an ornamental light in accordance with the present invention has a light bulb 10, a plug 20 and a socket 30.

The light bulb 10 has two wires 11 extending out from a bottom of the light bulb 10. The plug 20 has a cylindrical tube 21, an extension 22 integrally formed on a bottom of the cylindrical tube 21 and two auxiliary arms 23 formed on opposite sides of the extension 22. The socket 30 has two second wires 31 received therein and extending out therefrom to be connected to the two wires 11.

A slit 24 is defined through each of the auxiliary arms 23 to communicate with an inside of the cylindrical tube 21 so that an isolation wall 25 is formed between the two auxiliary arms 23.

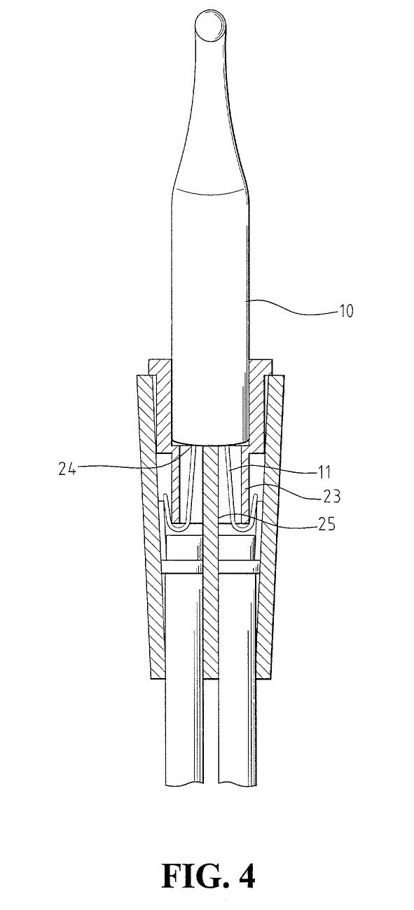

With reference to FIG. 4, when the ornamental light of the invention is assembled, the two second wires 31 are securely received in the socket 30 and separated by the extension 22. Each of the two wires 11, after the light bulb 10 is partially received in the cylindrical tube 21, extends out the plug 20 from a corresponding one of the slits 24 with the isolation wall 25 engages with the bottom of the light bulb 10.

Because the isolation wall 25 engages with the bottom of the light bulb 10, the two wires 11 are completely separated from each other so that the possibility of having a short is obviated.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A short proof plug for an ornamental light having a light bulb with two wires extending out from a bottom of the light bulb, the plug comprising:
a cylindrical tube adapted to receive therein a part of the light bulb;
an extension integrally formed on a bottom of the cylindrical tube; and
two auxiliary arms formed on opposite sides of the extension and each auxiliary arm having a slit defined through the auxiliary arms to communicate with an inside of the cylindrical tube so that an isolation wall is formed between the two auxiliary arms, wherein the isolation wall is adapted to engage with the bottom of the light bulb so as to isolate the two wires completely.
